(19) United States
(12) Patent Application Publication
(10) Pub. No.: US 2016/0288745 A1
(43) Pub. Date: Oct. 6, 2016

(54) AUTOMOTIVE FUSE HEADER ASSEMBLY

(71) Applicant: Sumitomo Wiring Systems, Ltd., Yokkaichi (JP)

(72) Inventor: Akihiro Max Matsumura, Northville, MI (US)

(21) Appl. No.: 15/090,913

(22) Filed: Apr. 5, 2016

Related U.S. Application Data
(60) Provisional application No. 62/143,436, filed on Apr. 6, 2015.

(51) Int. Cl. B60R 16/03; H01H 85/54

(52) U.S. Cl. CPC B60R 16/03; H01H 85/54; H01H 2085/0275

(57) ABSTRACT

A fuse header includes a housing with cavities and terminals mounted in the housing adjacent the cavities. Fuses can be mounted removably in the cavities so that the fuses connect to the terminals in the respective cavity. Ends of the terminals opposite the fuses have widths that are narrowed substantially and may equal the thickness of the terminals. The narrow widths impede a flow of heat from the fuse to large conductive regions on a circuit board that could function as a heat sink. Thus, the fuses will provide more reliable protection for components downstream of the fuses.

This disclosure claims the benefit of priority to U.S. Provisional Application No. 62/143,436, filed Apr. 6, 2015, the disclosure of which is incorporated herein in its entirety.

### BACKGROUND OF THE INVENTION

1. Field of the Invention

The invention relates to a fuse header assembly for a power distribution box or junction box of an automotive vehicle.

2. Description of the Related Art

A power distribution box or junction box for an automotive vehicle distributes power to various electrically powered components of the vehicle, such as the windshield wipers, the fuel pump, the water pump, cooling fans, an air conditioner compressor, power windows, power doors, door locks, power seats, the sound system, the navigation system and various lighting groups. The power distribution block includes at least one fuse header. The fuse header includes a thermoplastic or other resin housing in which fuses are mounted. The fuses are intended to protect the electrically powered components from damage that could be caused by excessively high current for a specified period of time. The maximum permitted current varies from one component to another. Accordingly, a fuse header is likely to have fuses with several different amperage ratings dictated by the maximum permitted current values for the respective component that is to be protected. The characteristics of the electrically powered components also determine the speed at which the fuse should act. Highly sensitive electrically powered components may require a fast blow fuse that will break or disrupt the power flow very quickly in response to a current flow that exceeds the rated current by a specified amount. Slow blow fuses generally are used with less sensitive electronic components and will cause the circuit to break when the current exceeds the rated current by a specified amount and for a specified duration.

The functioning of a fuse is based upon a relationship between current and temperature. The temperature of components in a fuse will increase as the current increases. A sufficient temperature for a sufficient time will cause an element in the fuse to break, thereby disrupting the circuit and preventing damage to the component that is to be protected by the fuse.

The upstream circuit side of a fuse generally is connected to wiring or other circuitry that has a large heat capacity. For example, a copper or copper alloy busbar may be disposed upstream of the fuse. It has been found that these circuit components with a large heat capacity act as heat sinks and draw heat away from the fuses. These circuit components with a large heat capacity create uneven temperature rises that cause variations in the time for the fuse to blow or that create other difficulties for the fuse to blow. For example, a fuse that is downstream of circuit component that acts as a heat sink may have difficult blowing at a steady-state current that is 135% of the rated current because of the element within the fuse that is intended to break at a specified current level may not reach the temperature associated with that current level, and hence will not break until the specified break temperature is achieved at a much higher current level. A fuse that is not blown at the designated amperage can lead to overheating of the component that is intended to be protected and could cause a thermal event.

It is an object of the subject invention to provide a fuse header that reliably stabilizes the fuse blowing characteristics.

### SUMMARY OF THE INVENTION

The invention relates to a fuse header that may be used in a power distribution box or junction box. The fuse header includes a nonconductive housing that may be configured to be mounted on a circuit board, such as a circuit board that is mounted in a power distribution box or a junction box of a vehicle. More particularly, the housing may have a mounting surface configured for mounting to the circuit board. The mounting surface may include locking projections to engage resiliently in locking holes formed in the circuit board. The housing may further include opposite front and rear ends spaced apart along a direction that will extend parallel to the board when the housing is mounted on the board. Sidewalls may extend between from the front end to or beyond the rear end. The sidewalls of the housing may project rearward beyond the rear ends of the cavities so that terminal fittings that project from the rear end of the housing are protected by the sidewalls. Bulges may extend out from the sidewalls, and each bulge may be configured to receive a mounting screw or bolt for securely holding the housing to the circuit board.

Cavities extend through the housing from the front-end to the rear end and may be arranged in a plurality of rows or stages at different distances from the mounting surface of the housing that will be mounted on the circuit board. Portions of the cavities adjacent the front end of the housing are configured respectively as fuse receptacles to receive fuses therein. The cavities are dimensioned and configured in accordance with the size and type of fuse that is to be mounted therein.

The fuse header further includes pairs of terminals mounted respectively into the cavities. The terminals in each pair define an upstream terminal that will receive the flow of current from a source and a downstream terminal that will supply the current to the component of the vehicle. However, the terminal of the fuse, and hence the terminal of the fuse header that connects to the upstream circuit may vary from one power distribution box to another depending upon circuit design constraints. Hence, the designer update fuse header may not know which of the terminals will connect to the upstream power source and which of the terminals will connect to the downstream component. Each of the terminals has a front end that is configured to mate with a terminal on the respective fuse. Front ends of some of the terminals will include two resiliently deflectable contact beams that are configured to engage opposite sides of a blade on a fuse. Other terminals will include front ends with a single blade that is configured to engage resiliently between a pair of terminals on the fuse. Each terminal may be bent at a location between the front and rear ends. Each bend may extend through an angle of 90° so that each terminal defines an L-shape.

The rear ends of the terminals preferably are narrowed and are configured for insertion into and/or through a conductive through hole in the circuit board. The connecting region at the rear end of each of terminal is narrowed and may have a thickness and a width that are substantially equal. The thickness of the terminal may be uniform throughout the length of the terminal. However, the width of the terminal is narrowed at the end that is connected to the circuit board and may substantially equal the thickness of the terminal. The equal width and thickness facilitates soldering to the circuit board. More importantly, this reduced cross-sectional dimension of the terminal at the circuit board limits the amount of heat that can flow through the terminal and to the busbar or other component upstream of the fuse and fuse header. As a result, the fuses have been found to perform more predictably and in accordance with the specified performance despite the presence of circuits upstream of the fuse with a large heat capacity and the ability to function as a heat sink. The equal thickness and width for the board-connecting portions of the terminals has been found to stabilize the fuse blow characteristics with a simple and versatile design.

### BRIEF DESCRIPTION OF THE DRAWINGS

FIG. 1 is an exploded perspective view of a housing and terminals of a fuse header assembly in accordance with an embodiment of the invention.

FIG. 2 is a bottom and front perspective view of the fuse header assembly of FIG. 1 with the terminals and fuses mounted in the housing.

FIG. 3 is a bottom and rear perspective view of the fuse header assembly of FIG. 2.

FIG. 4 is a front perspective view of the fuse header assembly without the fuses mounted therein.

FIG. 5 is a bottom plan view of the terminal of the fuse header terminal shown in FIG. 1.

FIG. 6 is a rear perspective view of the fuse header assembly of FIG. 1 with the terminals mounted in the housing and the housing mounted on a circuit board.

FIG. 7 is a bottom perspective view of the fuse header assembly and circuit board of FIG. 6.

### DETAILED DESCRIPTION OF THE PREFERRED EMBODIMENTS

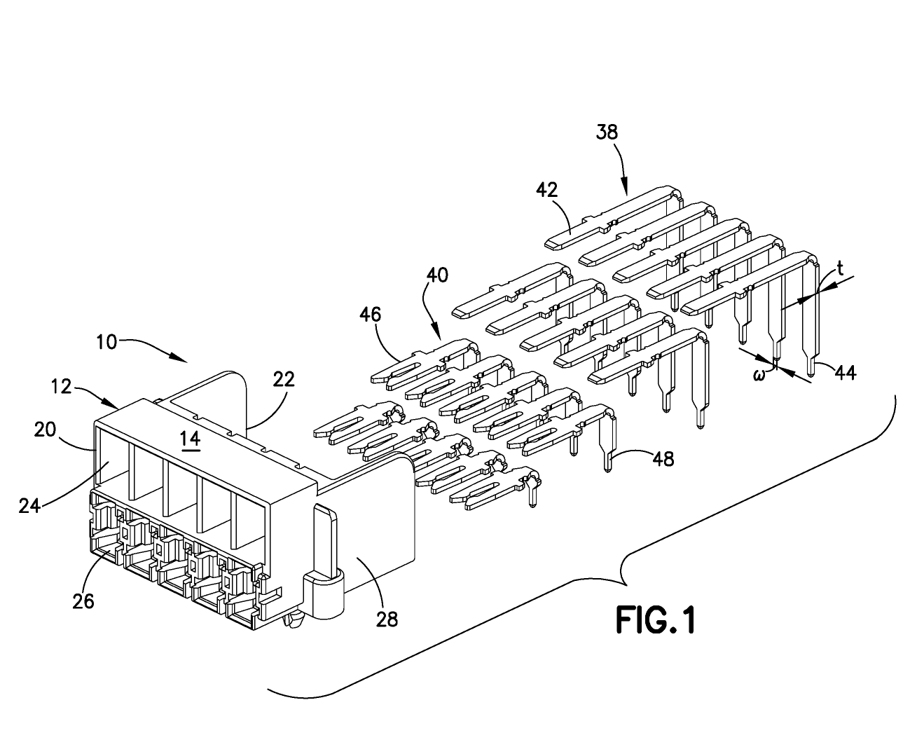

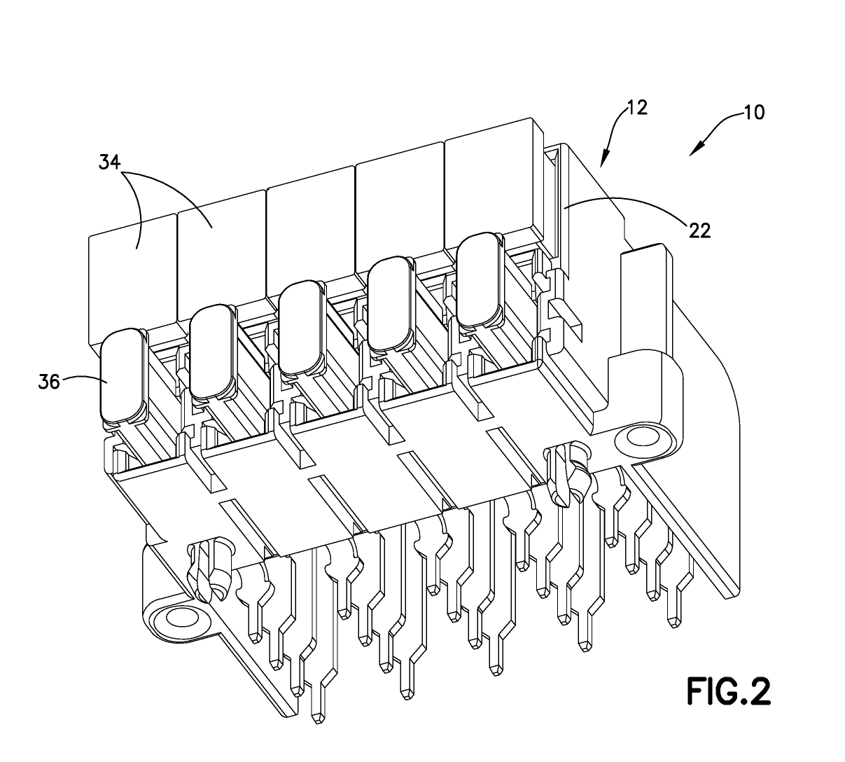

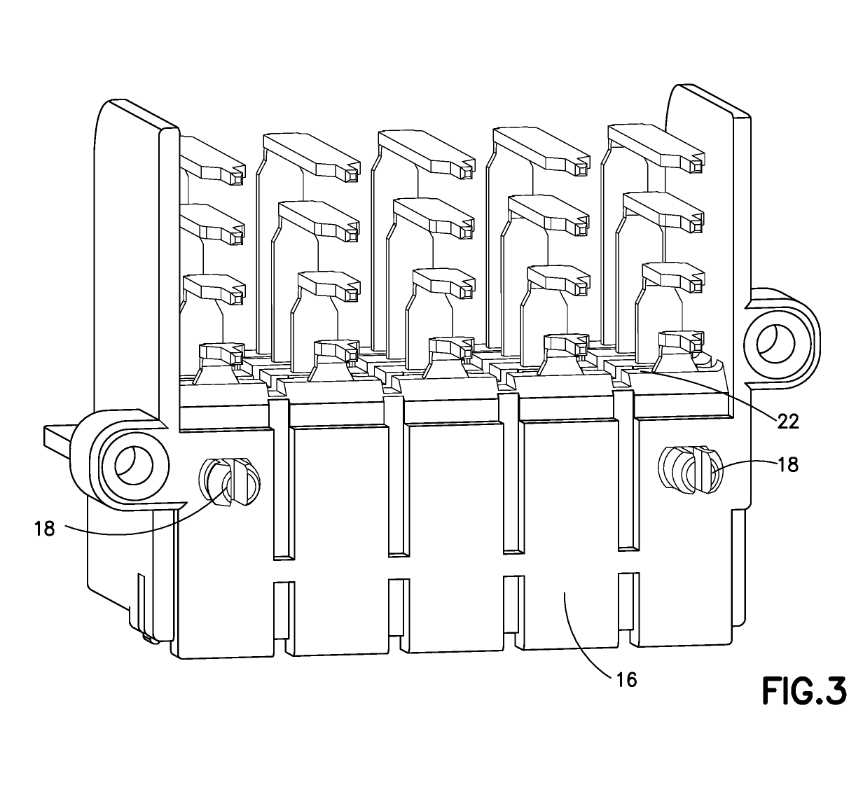

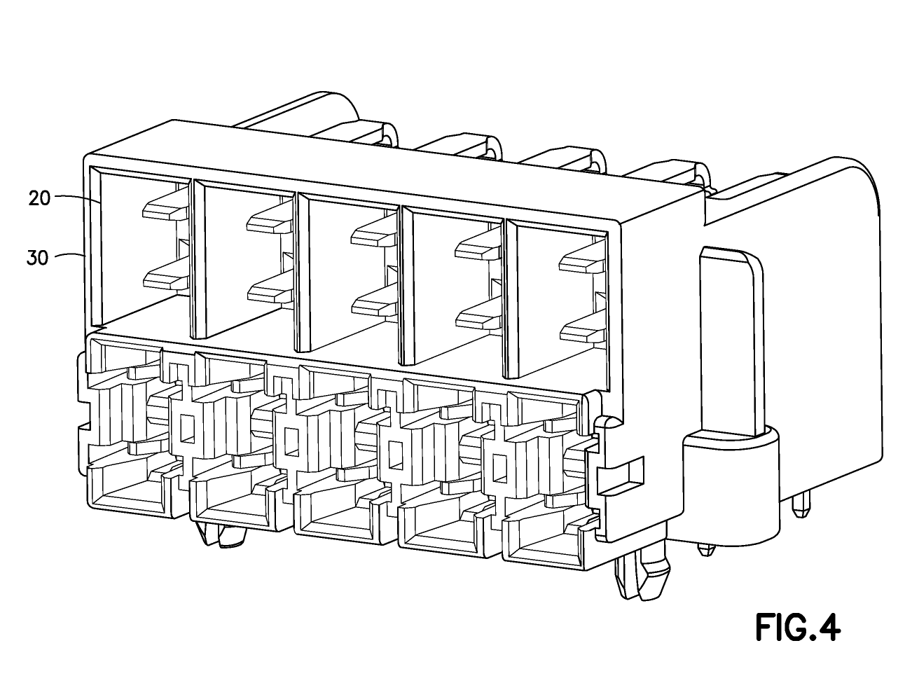

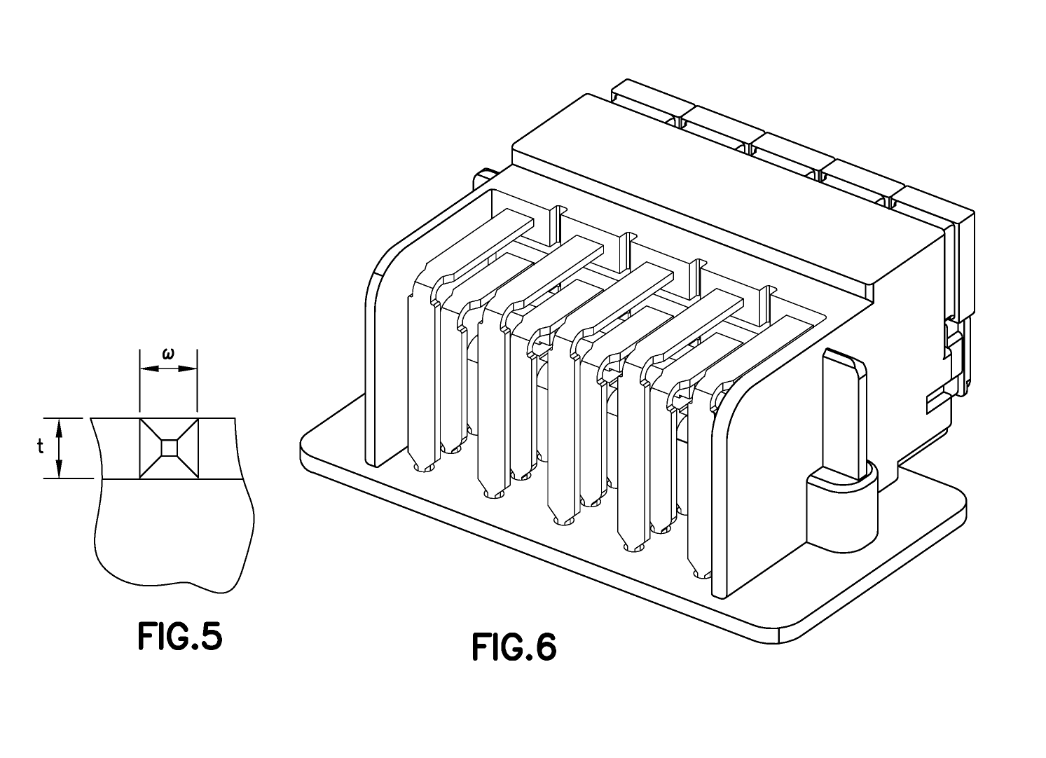

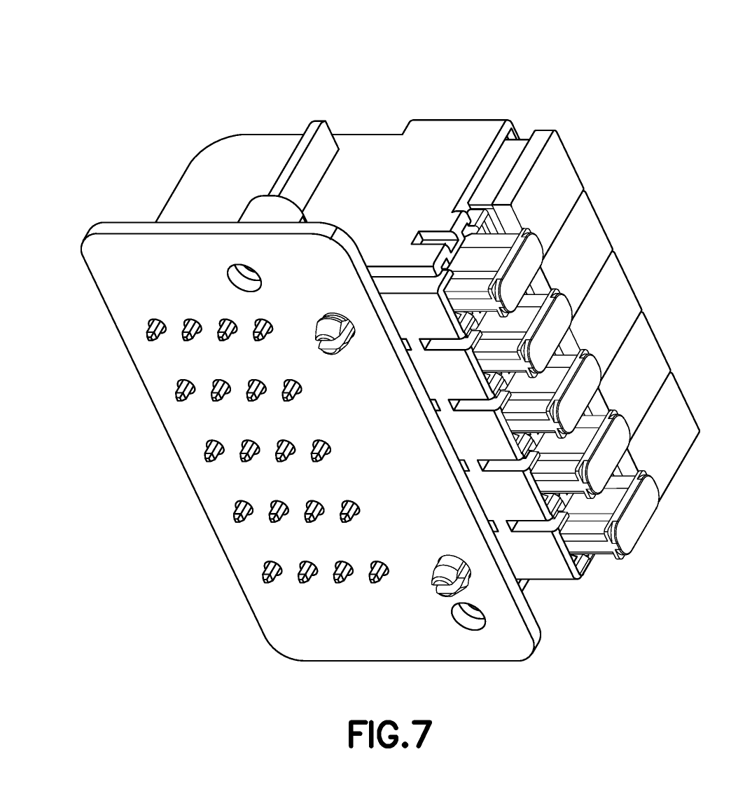

A fuse header in accordance with an embodiment of the subject invention is identified generally by the numeral 10 in FIGS. 1-4. The fuse header 10 includes a housing 12 with opposite upper and lower surfaces 14 and 16. The lower surface lower surface 16 is to be mounted on a circuit board, and mounting pegs 18 project from the lower surface 16. The mounting pegs 18 are disposed and dimensioned for resiliently locking to mounting apertures in the circuit board.

The housing 12 has opposite front and rear ends 20 and 22. Upper cavities 24 are disposed in a lateral array in proximity to the upper surface 14 of the housing 12 and lower cavities 26 are disposed in a lateral array in proximity to the lower surface 16 of the housing 12.

The housing 12 further includes opposite sidewalls 28 and 30 that extend from the front-end 20 of the housing 12 two positions rearward of the rear and 22 of the housing 12. Parts of the sidewalls that project rearward beyond the rear end 22 of the housing 12 provide protection for terminal fittings that project from the rear end 22 of the housing 12 as explained herein. Bulges 32 project laterally out from the sidewalls 28 and 30 respectively. The bulges 32 are formed with apertures for receiving bolts to secure the housing 12 on the circuit board.

Parts of the upper and lower cavities 24 and 26 adjacent the front and 20 of the housing 12 are configured to releasably receive fuses 34 and 36 respectively. More particularly, the upper cavities 24 are configured to receive slow blow fuses 34 adjacent the front and 20, while the lower cavities 26 are configured to receive fast below fuses 36.

The fuse header 10 further includes a plurality of upper terminals 38 and a plurality of lower terminals 40 arranged so that two of the upper terminals are arranged at vertically spaced positions in each of the upper cavities 24 and so that two of the lower terminals 40 are arranged at vertically spaced positions in each of the lower cavities 36. Each upper terminal 38 has a blade-shaped fuse mating end 42 configured for releasable engagement between resiliently deflectable contacts in the slow blow fuses 34 in the respective cavity 24. Each upper terminal 38 further has a board mounting end 44 opposite the fuse mating end 42. Portions of the upper terminals 38 between the ends 42 and 44 are bent at a substantially right angles so with that each upper terminal defines a substantially L-shape.

Each lower terminal 40 similarly has a fuse mating end 46 and a board mounting end 48. The fuse mating ends 46 of the lower terminals have to resiliently deflectable contact beams 50 that that engage opposite sides of a fuse blade. The board mounting end of each lower terminal 48 is configured identically or similarly to the board mounting ends 44 of each upper terminal 38.

The terminals 38, 40 have substantially uniform thicknesses “t” along their respective lengths. However, the terminals 38 and 45 widths that vary along the respective lengths in accordance with the functions that are to be performed and the strength that is required. For example, widths of the fuse mating ends 42, 46 are determined partly by the dimensions of the fuses 34, 36 and the cavities. Areas adjacent the fuse mating ends 42, 46 are widened to define stops for securely positioning the respective terminals 38, 40 in the cavities 24, 26 of the housing 12. Areas of each terminal 38, 40 in proximity to the L-shaped bends have widths to provide sufficient strength during the bending and to prevent deformation due to inadvertent contact. However, areas of each of the terminals 38, 40 at the board mounting ends 44, 48 thereof are narrowed to define widths “w” that may substantially equal to the thicknesses “t” of the terminals 38, 40.

The narrow widths “w” at the board mounting ends 44, 48 of the respective terminals 38, 40 impedes a flow of heat from the fuses 34, 36 through the terminals 38, 40 and to a conductive region on the circuit board that can function as a heat sink. As a result, heat generated in the fuses 34, 36 due to the current flowing through the fuses 34 and 36 will be more proportional to the current, and hence each fuse 34, 36 will exhibit a more predictable and reliable performance.

The invention has been described with respect to a preferred embodiment. However, it is apparent that various changes can be made without departing from the scope of the invention as set forth in the claims, and the skilled artisan will appreciate that other embodiments, including those mentioned below are within the scope of the claims.

The fuse header 10 described and illustrated above has both slow blow fuses and fast blow fuses. However, the fuse header 10 can be provided with an array of identical fuses.

The fuse header 10 described and illustrated above has two stages of fuses arranged one above the other. However, a single stage of fuses can be provided for more than two stages of fuses can be provided in the housing.

What is claimed is:

1. A fuse header assembly (10), comprising:
a housing (12) having opposite front and rear ends and at least one cavity (24, 26) extending between the ends, a portion of the cavity adjacent the front end defining a fuse receptacle and being configured for releasable mounting of a fuse (34, 36) therein; and
at least two terminals (38, 40) mounted in the cavity (24, 26) of the housing (12), each of the terminals (38, 40) having a fuse mating end (42, 46) projecting into the cavity (24, 26) and configured for mating with the fuse (34, 36) mounted in the fuse receptacle, each of the terminals (38, 40) further having a board mounting end (44, 48), the board mounting ends (44, 48) of each of the terminals (38, 40) having a width (w) and a thicknesses (t), the width (w) of the board mounting ends (44, 48) being narrower than widths of the terminals (38, 40) at locations between the board mounting ends (44, 48) and the fuse mating ends (42, 46) for impeding heat dissipation from the respective fuse (34, 36).

2. The fuse header assembly (10), of claim 1, wherein the width (w) and the thickness (t) of the board mounting end (44, 48) of the respective terminal (38, 40) are substantially equal.

3. The fuse header assembly (10), of claim 1, wherein the terminals (38, 40) comprise pairs of terminals (38, 40) for connection respectively to upstream and downstream terminals of the respective fuse (34, 36), the board mounting ends (44, 48) of the terminals (38, 40) in each of the pairs of terminals (38, 40) having substantially equal widths (w) and thicknesses (t) for impeding heat dissipation from the fuse (34, 36).

4. A power distribution box for an automotive vehicle comprising:
at least one circuit board having a busbar for carrying electric current to a component of the automotive vehicle;
a fuse header (10) having a housing (12) with cavities (24, 26) defining a fuse receptacle; and
terminals (38, 40) having fuse connecting ends (42, 46) projecting into each respective cavity (24, 26), each of the terminals (38, 40) further having a board mounting end (44, 48) for electrical connection to conductive regions on the circuit board, one of the terminals being an upstream terminal connected to the busbar, the board mounting ends of at least the upstream terminals having widths (w) and thicknesses (t), the width (w) of the board mounting ends (44, 48) being narrower than widths of the terminals (38, 40) at locations between the board mounting ends (44, 48) and the fuse mating ends (42, 46) for impeding a flow of heat from the fuse header (10) to the busbar for ensuring a specified performance of the fuse header (10).

5. The power distribution box of claim 4, further comprising fuses (34, 36) in the respective cavities (24, 26).

6. The power distribution box of claim 5, wherein the fuses (34, 36) comprise slow blow fuses.

7. The power distribution box of claim 6, wherein the fuses (34, 36) comprise fast blow fuses.

8. The power distribution box of claim 5, wherein the fuses (34, 36) comprise fast blow fuses.

9. The power distribution box of claim 4, wherein a width dimension of each of the terminals (38, 40) at locations spaced from the board mounting end (44, 48) exceeds the width (w) of the board mounting end (44, 48) of the respective terminal (38, 40).

10. The power distribution box of claim 4, wherein the terminals (38, 40) comprise pairs of terminals (38, 40), each of the pairs of terminals comprising one of the upstream terminals and a downstream terminal for connection respectively to upstream and downstream terminals of the respective fuse (34, 36), the board mounting ends of the downstream terminals having widths (w) and thicknesses (t) substantially equal to the widths (w) and thicknesses (t) of the upstream terminals.
